(19) United States
(12) Patent Application Publication
(10) Pub. No.: US 2006/0068857 A1
(43) Pub. Date: Mar. 30, 2006

(54) Hybrid mobile headset

(76) Inventor: Alexander M. Asseily, London (GB)

Correspondence Address: COURTNEY STANIFORD & GREGORY LLP, P.O. BOX 9686, SAN JOSE, CA, 95157, US

(21) Appl. No.: 11/195,534

(22) Filed: Aug. 1, 2005

Related U.S. Application Data
(60) Provisional application No. 60/592,675, filed on Jul. 30, 2004.

(51) Int. Cl. H04M 1/00

(52) U.S. Cl. 455/575.2

(57) ABSTRACT

Embodiments of a hybrid (wired/wireless) headset are described herein, including a mobile headset that provides users with the connectivity method most appropriate for a given scenario. In various embodiments, a hybrid wired/wireless headset is configurable to connect to a phone (or other connected device) using at least one of a wired mode and a wireless mode.

### RELATED APPLICATIONS

This application claims benifit of U.S. Provisional Patent Application Ser. No. 60/592,675, filed Jul. 30, 2004.

### FIELD OF THE INVENTION

Embodiments disclosed herein are in the field of wireless and wired communications headsets and other similar devices.

### BACKGROUND

Currently, mobile phone users wishing to talk ‘hands-free’ are able to use a mobile headset or carpiece. Most common are ‘wired’ headsets that consist of a connector (which may differ from phone to phone), a wire that conveys the electronic data from the phone to the ear(s), a speaker and/or a microphone which are mounted on or near the user's head in a plastic housing.

In the last few years, hands-free voice communications solutions of this kind have been enabled with wireless connectivity, most notably the ‘Bluetooth’ wireless standard, which eliminates the need for the wire. In this architecture, electronic audio signals are transmitted wirelessly from the phone to the headset (and vice versa) via radio-frequency transmission. The headset is equipped with the necessary wireless connectivity electronics, and a battery to power these electronics.

Both headsets, however, bear some significant advantages and disadvantages. While simple to use, the major limitation of wired headsets remains the inconvenience of having a wire dangling between the headset and the phone, something that restricts movement for the user and complicates storage of the product. However, although the wireless headset solves the issue of a cumbersome and restrictive wire, it adds the inconvenience of a battery, which needs to be recharged in order for the headset to be used consistently. If the battery is completely depleted, which can be the case after a few hours' use, the headset becomes unusable. Thus, users today are left with the choice between two imperfect alternatives.

### BRIEF DESCRIPTION OF THE DRAWINGS

FIG. 1 is a block diagram of a system according to an embodiment.

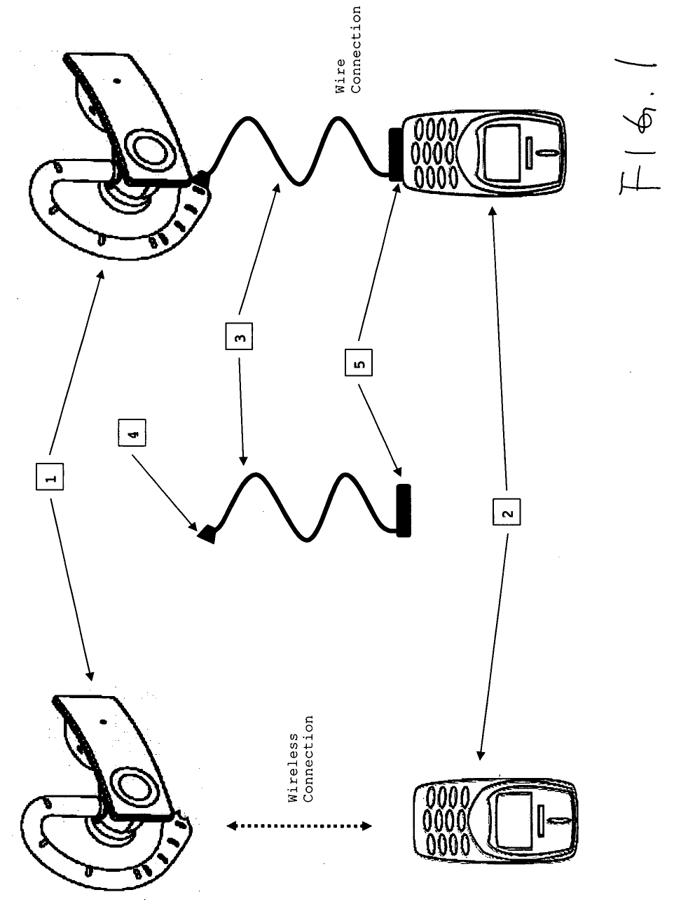

### DETAILED DESCRIPTION

The Hybrid (Wired/Wireless) Headset provided herein is a mobile headset design that provides users with the connectivity method most appropriate for a given scenario: a hybrid wired/wireless headset with the ability to connect to the phone (or other connected device) using at least one of wired and wireless modes:
The headset [1] includes the necessary wireless electronics (transceiver), such as the BlueCore 2 Bluetooth wireless chipset from Cambridge Silicon Radio (CSR) Ltd. This enables the headset to connect to the phone handset [2] as a standard wireless peripheral. The headset can also include a socket into which a matching multi-conductor plug could attach securely.
A separate cable accessory [3], provided together with or separately from the headset, is connected between the phone and the headset. At one end of the cable, there is a multi-conductor earpiece plug [4] that connects to the earpiece's matching socket. At the other end of the cable, there is a multi-conductor phone plug [5] that connects to the handset's matching socket, the specification of which may vary according to handset manufacturer. The cable is capable of doing, though not strictly limited to doing, one or more of the following functions:
   Trigger the headset to switch off the wireless transceiver;
   Re-route the audio channels directly through the wire to the phone, and vice versa.
   Provide power from the phone to the headset for either powering the electronics directly, or for recharging the battery inside the headset.
   Identify itself, and thus the identity of the connected phone, to the headset electronics to enable phone-specific features.
   Other communications.

Wire Specifications:

The cable of an embodiment communicates one or more of the following electronic information between the headset and the handset, depending on the specifications and capabilities of the handset model:
Microphone-Out (Outgoing Speech for Transmission by Phone)
Speaker-In (Incoming Audio for User's Speaker)
Power (To power headset electronics, or recharge battery)
Digital Communications (To permit digital data communication between headset electronics and handset electronics)

Note: The number of conductors used for transmitting each type of information above varies according to the specifications of the handset, as known in the art.

Thus the hybrid headset could be used in a variety of different modes. Three (of many) possible modes include the following, but the embodiments are not so limited:
1. Wireless mode—the headset is completely disconnected from the phone and the electronics are powered by the integrated battery.
2. Full Wired mode—the headset is connected to the phone with the wire accessory and all audio, data, and power signals are being re-routed through the wire (whether from the phone or from the headset).
3. Power Wired mode—the cable accessory is connected and only electrical power is routed from the phone to the headset in order to power the electronics and/or recharge the headset battery.

A headset including this functionality permits users to choose the connectivity solution that best suits their needs at a given time; it permits users to recharge their headset while on a call and on the move; it reduces the need for users to carry bulky recharging equipment when on travel; it allows users in areas of high electromagnetic noise interference to switch to a more secure wired connection. In the event the rechargeable battery is fully drained of energy, rendering the wireless headset inoperable, the wire would provide an immediate source of energy from the phone and allows the user to continue using the headset immediately.

The hybrid connectivity provided herein can be extended to a variety of different communications devices that might benefit from a hybrid wired/wireless connection. For example, the ‘headset’ described herein can be substituted with any number of devices, including but not limited to the following:
Mobile headset or earpiece (single ear mounting)
Mobile Stereo headset, earpiece, or headphones (two ears)
Multi-media head-mounted devices
Collar or body mounted communications devices.
Office/Call center headset
Aviation headset

Similarly, the ‘mobile phone’ described herein can be substituted by any number of devices, including but not limited to the following:
Mobile phone
Pager
Mobile email terminal
Smart Phone
Data gathering device
PDA
PC (desktop or laptop)
Car

In summary, the hybrid mobile handset described herein provides:
A hybrid mobile headset which can connect either wirelessly or through a wire.
A cable accessory for a wireless headset that can re-route audio, data, and power signal between the headset and the phone through the wire.
A cable accessory for a wireless headset that can deliver power from a phone to the headset during use in order to either power the wireless electronics or recharge the battery.

Aspects of the hybrid mobile headset described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the hybrid mobile headset include: microcontrollers with memory (such as electronically erasable programmable read only memory (EEPROM)), embedded microprocessors, firmware, software, etc. Furthermore, aspects of the hybrid mobile headset may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the hybrid mobile headset is not intended to be exhaustive or to limit the system to the precise form disclosed. While specific embodiments of, and examples for, the hybrid mobile headset are described herein for illustrative purposes, various equivalent modifications are possible within the scope of the system, as those skilled in the relevant art will recognize. The teachings of the hybrid mobile headset provided herein can be applied to other processing systems and communication systems, not only for the systems described above.

The elements and acts of the various embodiments described above can be combined to provide further embodiments. These and other changes can be made to the hybrid mobile headset in light of the above detailed description.

What we claim is:

1. A communications system, comprising:
a wireless transceiver;
at least one communications device; and
a multiconductor cable configurable to communicatively couple the wireless transceiver and the at least one communications device, and further configurable to recharge the wireless transceiver.

2. The system of claim 1, wherein the wireless transceiver is configurable to communicate with the at least one communications device, and comprises a device selected from a group comprising:
a radiofrequency device;
a magnetically coupled device; and
an electromagnetic device.

3. The system of claims wherein the wireless transceiver is configurable to be worn anywhere on the human body.

4. The system of claim 1, wherein the communications device comprises at least one of:
cellular telephones;
satellite telephones;
portable telephones;
wireline telephones;
Internet telephones;
wireless transceivers;
wireless communication radios;
personal digital assistants (PDAs);
VOIP telephones; and
personal computers (PCs).
